(19) United States
(12) Patent Application Publication
(10) Pub. No.: US 2024/0334429 A1
(43) Pub. Date: Oct. 3, 2024

(54) TRANSMISSION OF PACKET VIA MULTIPLE CONFIGURED GRANT CONFIGURATIONS

(71) Applicant: QUALCOMM Incorporated, San Diego, CA (US)

(72) Inventors: Huilin XU, Temecula, CA (US); Linhai HE, San Diego, CA (US); Ahmed ELSHAFIE, San Diego, CA (US); Diana MAAMARI, San Diego, CA (US)

(21) Appl. No.: 18/623,872

(22) Filed: Apr. 1, 2024

Related U.S. Application Data
(60) Provisional application No. 63/493,852, filed on Apr. 3, 2023.

(51) Int. Cl. H04W 72/1268; H04W 72/21

(52) U.S. Cl. CPC H04W 72/1268; H04W 72/21

(57) ABSTRACT

Various aspects of the present disclosure generally relate to wireless communication. In some aspects, a user equipment (UE) may transmit, in a first physical uplink shared channel (PUSCH) transmission occasion of a first configured grant (CG) configuration, first PUSCH data of a packet. The UE may transmit, in a second PUSCH transmission occasion of a second CG configuration, second PUSCH data of the packet. Numerous other aspects are described.

### CROSS-REFERENCE TO RELATED APPLICATION

This patent application claims priority to U.S. Provisional Patent Application No. 63/493,852, filed on Apr. 3, 2023, entitled “TRANSMISSION OF PACKET VIA MULTIPLE CONFIGURED GRANT CONFIGURATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for transmission of a packet via multiple configured grant configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to transmit, in a first physical uplink shared channel (PUSCH) transmission occasion of a first configured grant (CG) configuration, first PUSCH data of a packet. The one or more processors may be configured to transmit, in a second PUSCH transmission occasion of a second CG configuration, second PUSCH data of the packet.

Some aspects described herein relate to a network node for wireless communication. The network node may include a memory and one or more processors coupled to the memory. The one or more processors may be configured to obtain, in a first PUSCH transmission occasion of a first CG configuration, first PUSCH data of a packet. The one or more processors may be configured to obtain, in a second PUSCH transmission occasion of a second CG configuration, second PUSCH data of the packet.

Some aspects described herein relate to a method of wireless communication performed by a UE. The method may include transmitting, in a first PUSCH transmission occasion of a first CG configuration, first PUSCH data of a packet. The method may include transmitting, in a second PUSCH transmission occasion of a second CG configuration, second PUSCH data of the packet.

Some aspects described herein relate to a method of wireless communication performed by a network node. The method may include obtaining, in a first PUSCH transmission occasion of a first CG configuration, first PUSCH data of a packet. The method may include obtaining, in a second PUSCH transmission occasion of a second CG configuration, second PUSCH data of the packet.

Some aspects described herein relate to a non-transitory computer-readable medium that stores a set of instructions for wireless communication by a UE. The set of instructions, when executed by one or more processors of the UE, may cause the UE to transmit, in a first PUSCH transmission occasion of a first CG configuration, first PUSCH data of a packet. The set of instructions, when executed by one or more processors of the UE, may cause the UE to transmit, in a second PUSCH transmission occasion of a second CG configuration, second PUSCH data of the packet.

Some aspects described herein relate to a non-transitory computer-readable medium that stores a set of instructions for wireless communication by a network node. The set of instructions, when executed by one or more processors of the network node, may cause the network node to obtain, in a first PUSCH transmission occasion of a first CG configuration, first PUSCH data of a packet. The set of instructions, when executed by one or more processors of the network node, may cause the network node to obtain, in a second PUSCH transmission occasion of a second CG configuration, second PUSCH data of the packet.

Some aspects described herein relate to an apparatus for wireless communication. The apparatus may include means for transmitting, in a first PUSCH transmission occasion of a first CG configuration, first PUSCH data of a packet. The apparatus may include means for transmitting, in a second PUSCH transmission occasion of a second CG configuration, second PUSCH data of the packet.

Some aspects described herein relate to an apparatus for wireless communication. The apparatus may include means for obtaining, in a first PUSCH transmission occasion of a first CG configuration, first PUSCH data of a packet. The apparatus may include means for obtaining, in a second PUSCH transmission occasion of a second CG configuration, second PUSCH data of the packet.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5 is a diagram illustrating examples involving uplink data that is transmitted during a CG period, in accordance with the present disclosure.

FIG. 6 is a diagram illustrating an example associated with transmission of a packet via multiple CG configurations, in accordance with the present disclosure.

FIG. 7 is a diagram illustrating an example associated with a configured packet transmission period during which a first CG configuration is configured and a second CG configuration is configured, in accordance with the present disclosure.

FIG. 8 is a diagram illustrating an example of an implicit indication to switch from the first CG configuration to the second CG configuration, in accordance with the present disclosure.

FIG. 9 is a diagram illustrating an example associated with uplink control information (UCI) that includes an indication to switch to the second CG configuration, in accordance with the present disclosure.

FIG. 10 is a diagram illustrating an example associated with a minimum time duration between transmission of first physical uplink shared channel (PUSCH) data or uplink control information (UCI) that includes an indication to switch to the second CG configuration and transmission of second PUSCH data, in accordance with the present disclosure.

FIG. 11 is a diagram illustrating examples associated with a start time associated with the second CG configuration, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Jitter arises when data generation and transfer is subject to random processing times and/or random communication times. Jitter can introduce uncertainty regarding the start time of uplink data transmission by configured grant (CG) physical uplink shared channels (PUSCHs). For example, jitter may subject the uplink data transmission to a random time offset from the start time of a CG period. As a result, a user equipment (UE) may start transmitting the uplink data after a random quantity of PUSCH transmission occasions in the CG period. As a result, a network node blindly detects the uplink data by monitoring each PUSCH transmission occasion in the CG period. Thus, the network node may consume power to monitor PUSCH transmission occasions that do not contain any uplink data.

In some implementations provided herein, a UE may transmit, and a network node may obtain, in a first PUSCH transmission occasion of a first CG configuration, first PUSCH data of a packet. The UE may further transmit, and the network node may obtain, in a second PUSCH transmission occasion of a second CG configuration, second PUSCH data of the packet.

Transmitting the first PUSCH data in a first PUSCH transmission occasion of a first CG configuration and the second PUSCH data in a second PUSCH transmission occasion of a second CG configuration may reduce power consumption involved in detecting the first PUSCH data. For example, the first and second CG configurations may have different PUSCH transmission occasion densities. For example, the PUSCH transmission occasions of the first CG configuration may be less dense than the PUSCH transmission occasions of the second CG configuration.

During the first CG configuration (e.g., when the PUSCH transmission occasions are sparser than the PUSCH transmission occasions of the second CG configuration), the network node may monitor fewer PUSCH transmission occasions—and, thus, expend less energy—than the network node would monitor if the PUSCH transmission occasions of the first CG configuration were to occur as often as the PUSCH transmission occasions of the second CG configuration. The PUSCH transmission occasions of the second CG configuration may be denser than the PUSCH transmission occasions of the first CG configuration, which may enable the network node to obtain all PUSCH data of the packet with faster uplink data transmission than the network node would obtain all PUSCH data of the packet if the UE were to continue to transmit the PUSCH data at the rate of the PUSCH transmission occasions of the first CG configuration.

In some examples, the network node may switch from the first CG configuration to the second CG configuration after receiving a PUSCH transmission occasion that is used by the UE to transmit the PUSCH data of the packet. The switch may be triggered by an implicit indication to switch (e.g., the first PUSCH data) or by an explicit indication to switch (e.g., uplink control information (UCI)).

In a case of an implicit indication to switch, the network node may autonomously switch between the first CG configuration and the second CG configuration in response to detecting the first PUSCH data. Thus, the first PUSCH data may be an indication to switch from the first CG configuration to the second CG configuration. Using the first PUSCH data as an indication to switch from the first CG configuration to the second CG configuration may avoid additional signaling regarding the switching and, as a result, may reduce overhead.

In a case of an explicit indication to switch, the UE may transmit, and the network node 110 may receive, an indication (e.g., an explicit indication, such as UCI) to switch to the second CG configuration. Transmitting the indication to switch to the second CG configuration may increase robustness, for example, by helping to ensure that the network node 110 switches to the second CG configuration.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

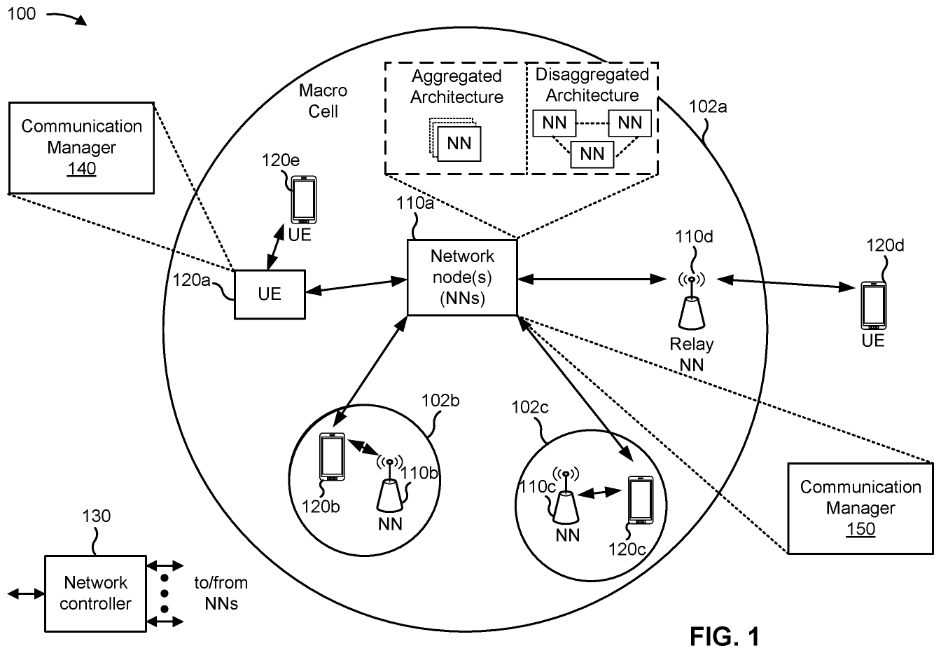

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, in a first PUSCH transmission occasion of a first CG configuration, first PUSCH data of a packet; and transmit, in a second PUSCH transmission occasion of a second CG configuration, second PUSCH data of the packet. Additionally, or alternatively, the communication manager 140 may perform one or more other operations described herein.

In some aspects, the network node 110 may include a communication manager 150. As described in more detail elsewhere herein, the communication manager 150 may obtain, in a first PUSCH transmission occasion of a first CG configuration, first PUSCH data of a packet; and obtain, in a second PUSCH transmission occasion of a second CG configuration, second PUSCH data of the packet. Additionally, or alternatively, the communication manager 150 may perform one or more other operations described herein.

As indicated above, FIG. 1 is provided as an example. Other examples may differ from what is described with regard to FIG. 1.

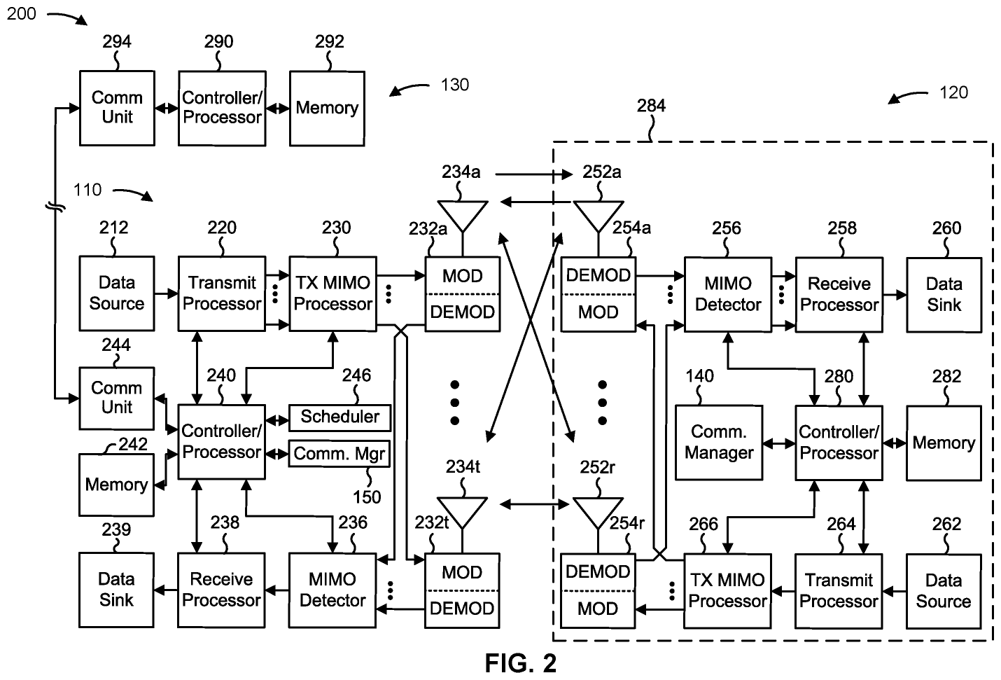

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

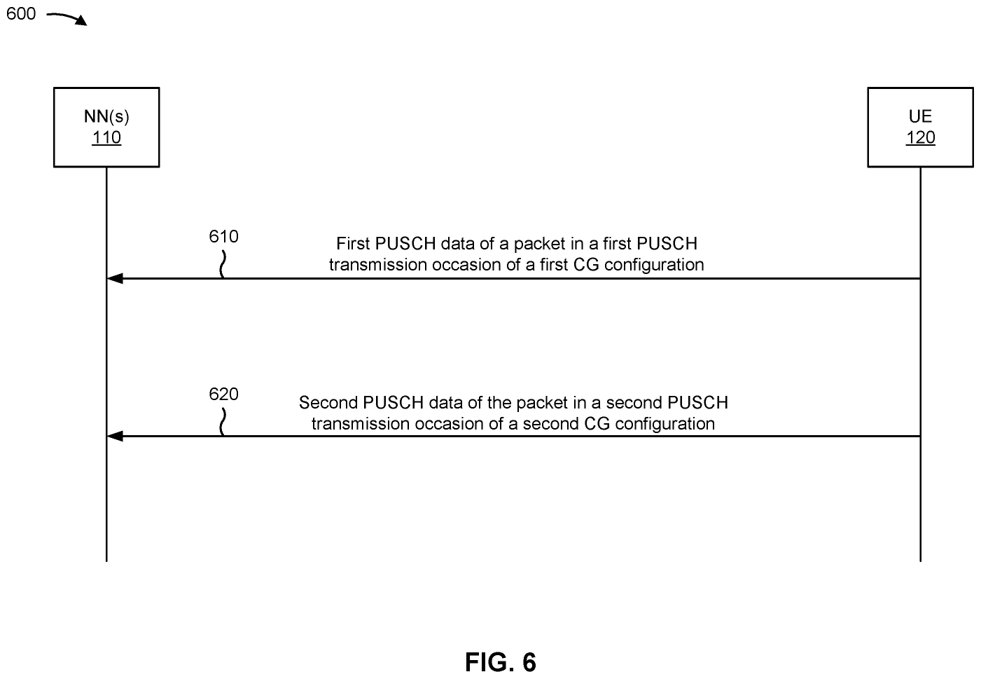

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-15).

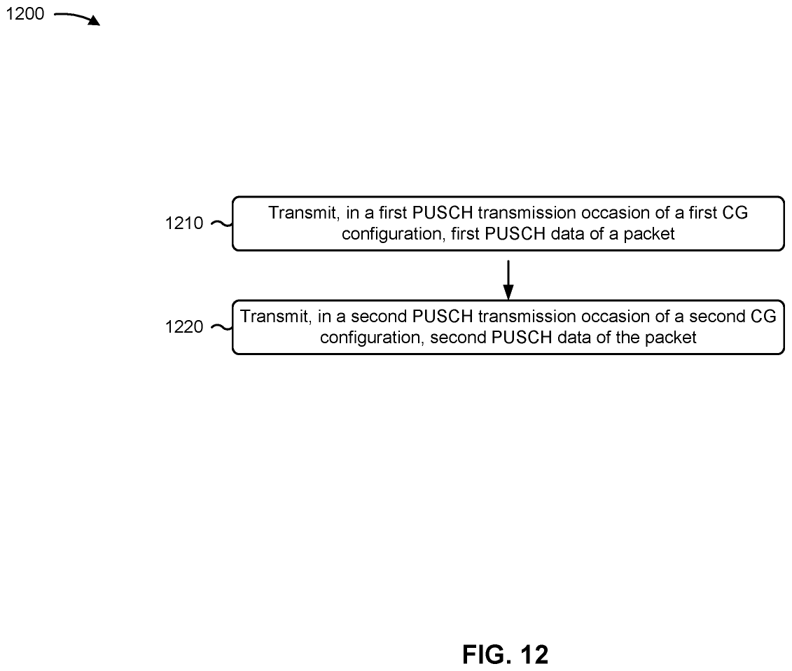

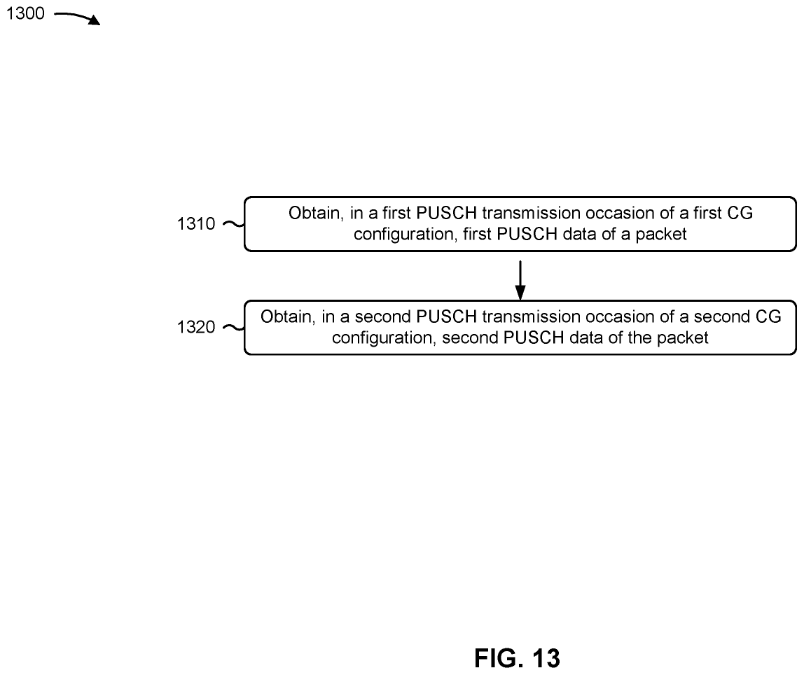

The controller/processor 240 of the network node 110, the controller/processor 280 of the UE 120, and/or any other component(s) of FIG. 2 may perform one or more techniques associated with transmission of a packet via multiple CG configurations, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for transmitting, in a first PUSCH transmission occasion of a first CG configuration, first PUSCH data of a packet; and/or means for transmitting, in a second PUSCH transmission occasion of a second CG configuration, second PUSCH data of the packet. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining, in a first PUSCH transmission occasion of a first CG configuration, first PUSCH data of a packet; and/or means for obtaining, in a second PUSCH transmission occasion of a second CG configuration, second PUSCH data of the packet. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

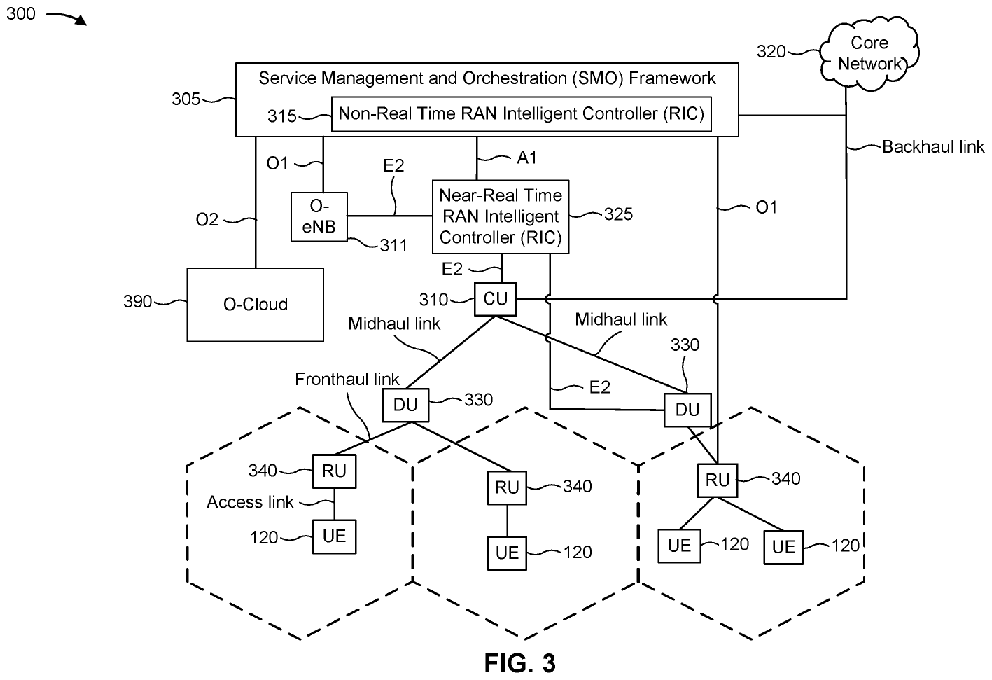

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

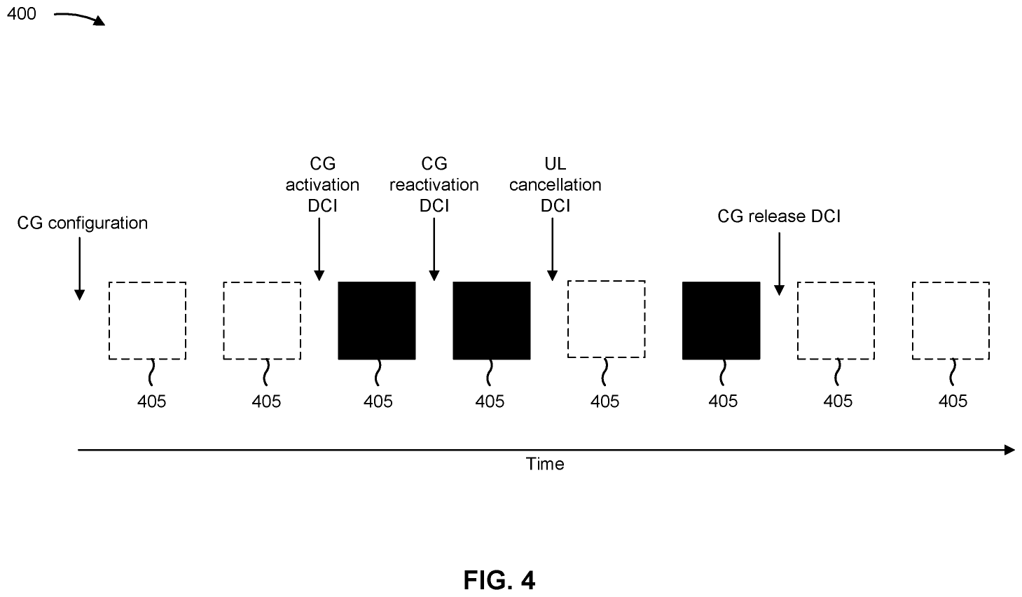

FIG. 4 is a diagram illustrating an example 400 of uplink CG communication, in accordance with the present disclosure. CG communications may include periodic uplink communications that are configured for a UE, such that the network node does not need to send separate downlink control information (DCI) to schedule each uplink communication, thereby reducing latency and signaling overhead.

As shown in example 400, a UE may be configured with a CG configuration for grant-free uplink communications. For example, the UE may receive the CG configuration via an RRC message transmitted by a network node. The CG configuration may indicate a resource allocation associated with CG uplink communications (e.g., in a time domain, frequency domain, spatial domain, and/or code domain) and a periodicity at which the resource allocation is repeated, resulting in periodically recurring scheduled CG occasions 405 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network node may transmit CG activation DCI to the UE to activate the CG configuration for the UE. The network node may indicate, in the CG activation DCI, communication parameters, such as an MCS, an RB allocation, and/or antenna ports, for the CG PUSCH communications to be transmitted in the scheduled CG occasions 405. The UE may begin transmitting in the CG occasions 405 based at least in part on receiving the CG activation DCI. For example, beginning with a next scheduled CG occasion 405 subsequent to receiving the CG activation DCI, the UE may transmit a PUSCH communication in the scheduled CG occasions 405 using the communication parameters indicated in the CG activation DCI. The UE may refrain from transmitting in configured CG occasions 405 prior to receiving the CG activation DCI.

The network node may transmit CG reactivation DCI to the UE to change the communication parameters for the CG PUSCH communications. Based at least in part on receiving the CG reactivation DCI, and the UE may begin transmitting in the scheduled CG occasions 405 using the communication parameters indicated in the CG reactivation DCI. For example, beginning with a next scheduled CG occasion 405 subsequent to receiving the CG reactivation DCI, the UE may transmit PUSCH communications in the scheduled CG occasions 405 based at least in part on the communication parameters indicated in the CG reactivation DCI.

In some cases, such as when the base station needs to override a scheduled CG communication for a higher priority communication, the network node may transmit UL cancellation DCI to the UE to temporarily cancel or deactivate one or more subsequent CG occasions 405 for the UE. The UL cancellation DCI may deactivate only a subsequent one CG occasion 405 or a subsequent N CG occasions 405 (where N is an integer). CG occasions 405 after the one or more (e.g., N) CG occasions 405 subsequent to the UL cancellation DCI may remain activated. Based at least in part on receiving the UL cancellation DCI, the UE may refrain from transmitting in the one or more (e.g., N) CG occasions 405 subsequent to receiving the UL cancellation DCI. As shown in example 400, the UL cancellation DCI cancels one subsequent CG occasion 405 for the UE. After the CG occasion 405 (or N CG occasions) subsequent to receiving the UL cancellation DCI, the UE may automatically resume transmission in the scheduled CG occasions 405.

The network node may transmit CG release DCI to the UE to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received from the base station. Whereas the UL cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

CGs configured with one PUSCH transmission occasion per CG period (also referred to herein as legacy CGs) may be suitable for periodic uplink traffic with relatively small-sized packets. For example, legacy CGs may be used to transmit voice, control messages for industrial internet of things (IIoT), poses for extended reality (XR) applications, or the like.

NR may allow CGs to be configured with multiple PUSCH transmission occasions per CG period. CGs configured with multiple PUSCH transmission occasions per CG period may be suitable for periodic uplink traffic with relatively large-sized packets, such as video traffic generated by user applications (e.g., augmented reality (AR) scenes captured by video surveillance cameras). Supporting multiple CG PUSCH transmission occasions in a period of a single CG PUSCH configuration may help reduce overhead.

As indicated above, FIG. 4 is provided as an example. Other examples may differ from what is described with respect to FIG. 4.

Downlink jitter may be handled using adaptive physical downlink control channel (PDCCH) monitoring before and after a downlink data arrival time when jitter is present. Before the downlink data arrival time, the UE may use sparse PDCCH monitoring, which may conserve UE power that would otherwise be used for PDCCH monitoring when no downlink data is scheduled by the network. After the downlink data arrival time, the UE may switch to dense PDCCH monitoring, which may enable the UE to quickly receive the downlink data (e.g., with low latency).

However, handling of jitter present in uplink data transmission by CG PUSCHs has not been considered. Jitter can introduce uncertainty regarding the start time of uplink data transmission by CG PUSCHs. For example, the arrival times of uplink XR traffic may vary due to jitter. “XR” is an umbrella term that covers immersive technologies such as virtual reality (VR), AR, mixed reality (MR), and levels of virtuality interpolated among VR, AR, and MR. An XR device may provide rendered data (e.g., video data or XR data) via a display of the XR device. For example, the XR device may provide VR video data that has been rendered for a user based on a location of the user, an orientation of the user and/or the XR device, or a state of an application generating the VR video data, among other examples.

Rendering data in real-time for XR services may cause an XR device to use relatively large amounts of processing resources and/or power resources. However, some XR devices may have limited processing resources and/or power resources, which may limit an amount of data that some XR devices can render in real-time. This may result in an XR device down-selecting to a lower quality of video or may cause gaps or artifacts in video provided by the XR device, among other issues.

Split rendering can be used to offload some rendering tasks from an XR device with limited resources. For example, an XR device can offload a rendering task to another device (e.g., a UE) with a greater availability of computing resources and/or power resources relative to the XR device. In some cases, the XR device may split a rendering task such that some of the rendering task is performed remotely by the other device and some of the rendering task is performed locally by the XR device.

However, jitter arises when data generation and transfer (e.g., between an XR device and a UE) is subject to random processing time and random communication time. The processing time may be random depending on the nature of the uplink data. For example, if an XR device (e.g., a video surveillance camera) provides video data (e.g., AR data) to a UE for rendering, then the processing time may depend on the video data. For example, in case of a moving object in the video, each video frame may be substantially different than the previous frame, which may hinder video compression at the UE, thereby increasing processing time. The communication time may be random because UE resources may or may not be occupied when an XR device attempts to transmit raw uplink data to the UE for rendering. Thus, when transmitted from the UE to a network node, the uplink data may be impacted by jitter.

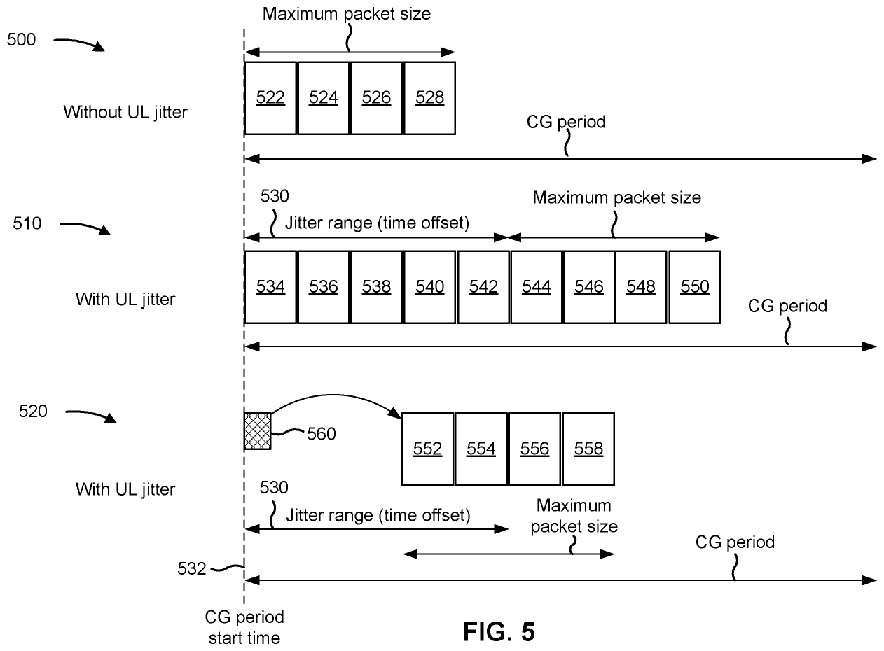

FIG. 5 is a diagram illustrating example 500, example 510, and example 520 involving uplink data that is transmitted during a CG period and is or is not impacted by jitter, in accordance with the present disclosure. For example, the uplink data may be a packet of XR video data that is subject to jitter. As shown, the maximum packet size for the packet is four PUSCH transmission occasions 522, 524, 526, and 528 (e.g., CG PUSCH monitoring occasions). The CG periodicity may be aligned with the uplink data generation periodicity (e.g., 60 frames per second).

In example 500, no jitter is present and, as a result, the UE transmits the uplink data starting at PUSCH transmission occasion 522 (e.g., the first PUSCH transmission occasion of the CG period). Thus, the UE may quickly (e.g., with low latency) finish transmitting the uplink data in the allocated PUSCH transmission occasions 522, 524, 526, and 528. In this example, only a subset of PUSCH transmission occasions in the CG period are used for the uplink data transmission.

In example 510 and example 520, jitter is present. As shown, the jitter subjects the uplink data transmission to a random time offset 530 from the start time 532 of the CG period. As a result, the UE starts transmitting the uplink data after a random quantity of PUSCH transmission occasions. In example 510, the first five PUSCH transmission occasions 534, 536, 538, 540, and 542 of the CG period are allocated to cover the jitter range, and the uplink data transmission starts at the sixth PUSCH transmission occasion 544 of the CG period, resulting in a worst-case scenario for jitter in which the actual jitter time is equal to the maximum possible jitter time.

In example 510, the network (e.g., the network node) blindly detects the uplink data by monitoring each PUSCH transmission occasion in the CG period, including PUSCH transmission occasions 534, 536, 538, 540, 542, 544, 546, 548, and 550. For example, the network node may detect the jitter time by monitoring PUSCH transmission occasions 534, 536, 538, 540, 542 (e.g., the first five PUSCH transmission occasions in the CG period). Thus, the network node may consume power to monitor PUSCH transmission occasions that do not contain any uplink data. Of example 500, example 510, and example 520, example 510 may involve the highest power consumption for the network node to detect CG PUSCHs.

In example 520, the UE informs the network node of the actual start time of the first PUSCH transmission occasion to be used for the uplink data transmission (e.g., PUSCH transmission occasion 552). In some examples, PUSCH transmission occasions 554, 556, and 558 may also be used for the uplink data transmission. For example, the UE may inform the network node of the actual start time via a UE indication 560 of unused PUSCH transmission occasions. The indication 560 of unused PUSCH transmission occasions may allow the UE to indicate unused uplink CG resources when the uplink data size is random, but may also be used to indicate the actual data start time in presence of jitter. For example, the indication 560 of unused PUSCH transmission occasions may be a dynamic indication of unused CG PUSCH occasion(s). The dynamic indication may be based on UCI, such as a CG UCI (CG-UCI) or a dedicated UCI. The UCI may be carried in the physical uplink control channel (PUCCH) and indicate that the first one or more PUSCH transmission occasions are unused in the CG period (e.g., that the first one or more PUSCH transmission occasions occur before the uplink data is ready for transmission).

Although example 520 may enable UE to inform the network node to start detecting the PUSCH when the uplink data is transmitted in one of the configured CG PUSCH occasions, and may therefore reduce power consumed by the network node to detect CG PUSCHs (e.g., power consumed to monitor PUSCH transmission occasions before the uplink data transmission), example 520 is also impractical in many cases. Example 520 may be achieved only if the jitter is predictable or known beforehand to the UE (e.g., if the uplink jitter is predictable at the UE physical layer). Depending on the cause of the jitter, the UE often cannot predict the jitter (e.g., the jitter time). Because the jitter time is typically unpredictable to the UE in the physical layer before the uplink data is ready for transmission, example 520 cannot be employed for power reduction in many use cases (e.g., in many XR device use cases).

FIG. 6 is a diagram illustrating an example 600 associated with transmission of a packet via multiple CG configurations, in accordance with the present disclosure. As shown in FIG. 6, a network node 110 and a UE 120 may communicate with one another.

As shown by reference number 610, the UE 120 may transmit, and the network node 110 may obtain, in a first PUSCH transmission occasion of a first CG configuration, first PUSCH data of a packet. The first PUSCH data of the packet may be initial PUSCH data of the packet (e.g., the first PUSCH transmission occasion may be an initial PUSCH transmission occasion of all PUSCH transmission occasions carrying PUSCH data of the packet). In some examples, the first CG configuration may be configured with a plurality of PUSCH transmission occasions.

The first PUSCH data may be video (e.g., captured by an AR camera), and the packet may be an application-layer data packet. The UE 120 may transmit the first PUSCH data during a configured packet transmission period (e.g., a period configured for transmission of the packet). The configured packet transmission period may correspond to a period configured for transmission of application data.

As shown by reference number 620, the UE 120 may transmit, and the network node 110 may obtain, in a second PUSCH transmission occasion of a second CG configuration, second PUSCH data of the packet. For example, the UE 120 may transmit the second PUSCH data in the second PUSCH transmission occasion during the configured packet transmission period. The UE 120 may transmit the first PUSCH data before transmitting the second PUSCH data (e.g., the second PUSCH transmission occasion may occur after the first PUSCH transmission occasion). In some examples, the second CG configuration may be configured with a plurality of PUSCH transmission occasions.

Transmitting the first PUSCH data in a first PUSCH transmission occasion of a first CG configuration and the second PUSCH data in a second PUSCH transmission occasion of a second CG configuration may reduce power consumption involved in detecting the first PUSCH data. For example, the first and second CG configurations may have different PUSCH transmission occasion densities. For example, the PUSCH transmission occasions of the first CG configuration may be less dense than the PUSCH transmission occasions of the second CG configuration.

In some examples, the PUSCH transmission occasions of the first CG configuration may be less dense than the PUSCH transmission occasions of the second CG configuration when the PUSCH transmission occasions of the first CG configuration include non-consecutive PUSCH transmission occasions and the PUSCH transmission occasions of the second CG configuration may include consecutive PUSCH transmission occasions. For example, the first (e.g., initial) CG configuration may be configured with non-consecutive PUSCH transmission occasions in non-consecutive slots, and the second CG configuration may be configured with consecutive PUSCH transmission occasions in consecutive slots.

In some examples, the PUSCH transmission occasions of the first CG configuration may be less dense than the PUSCH transmission occasions of the second CG configuration when the PUSCH transmission occasions of the first CG configuration are down-sampled relative to the PUSCH transmission occasions of the second CG configuration. For example, the first CG configuration may be configured with a down-sampling factor relative to the second CG configuration. For example, the first CG configuration may be configured with one PUSCH transmission occasion for every N (e.g., two) PUSCH transmission occasions configured for the second CG configuration. The second CG configuration may not be impacted by the down-sampling factor.

During the first CG configuration (e.g., when the PUSCH transmission occasions are sparser than the PUSCH transmission occasions of the second CG configuration) the network node 110 may monitor fewer PUSCH transmission occasions—and, thus, expend less energy—than the network node 110 would monitor if the PUSCH transmission occasions of the first CG configuration were to occur as often as the PUSCH transmission occasions of the second CG configuration. The PUSCH transmission occasions of the second CG configuration may be denser than the PUSCH transmission occasions of the first CG configuration, which may enable the network node 110 to obtain all PUSCH data of the packet with faster uplink data transmission than the network node 110 would obtain all PUSCH data if the UE 120 were to continue to transmit the PUSCH data at the rate of the PUSCH transmission occasions of the first CG configuration.

As indicated above, FIG. 6 is provided as an example. Other examples may differ from what is described with respect to FIG. 6.

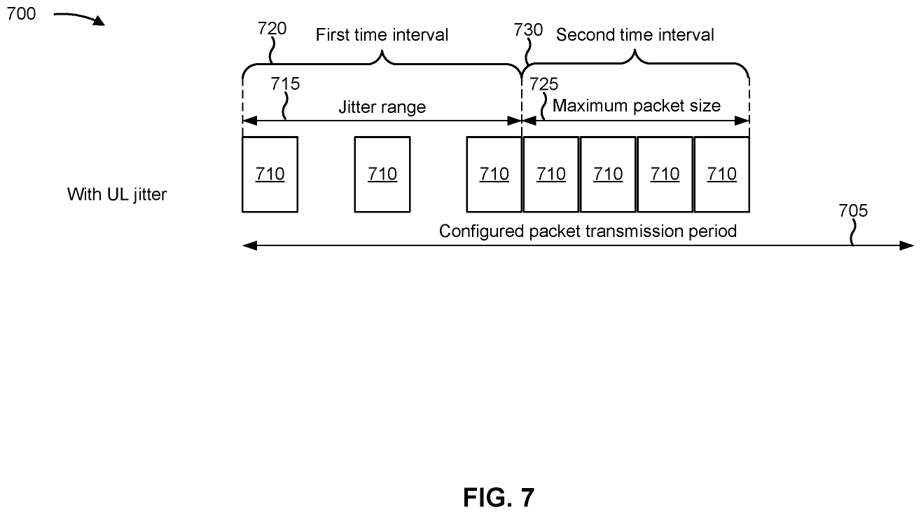

FIG. 7 is a diagram illustrating an example 700 associated with a configured packet transmission period 705 during which a first CG configuration is configured and a second CG configuration is configured, in accordance with the present disclosure. As shown, multiple PUSCH transmission occasions 710 occur during the configured packet transmission period 705. Initially (e.g., in a jitter range 715 that occurs during a first time interval 720 in which jitter may delay the transmission of uplink data of a packet having a maximum packet size 725), the PUSCH transmission occasions may be relatively sparse. Subsequently (e.g., during a second time interval 730 in which the uplink data of the packet is transmitted), the PUSCH transmission occasions may be relatively dense. The network node may reduce power consumption by blindly detecting PUSCH transmissions in the sparser PUSCH transmission occasions and switching to the denser PUSCH transmission occasions after detecting uplink data in a PUSCH transmission occasion.

As indicated above, FIG. 7 is provided as an example (e.g., an example of a worst-case scenario for jitter in which the actual jitter time is equal to the maximum possible jitter time). Other examples may differ from what is described with respect to FIG. 7.

The network node 110 may switch from the first CG configuration to the second CG configuration after receiving an initial PUSCH transmission occasion that is used by the UE 120 to transmit the PUSCH data of the packet. For example, the first PUSCH transmission occasion may be the initial PUSCH transmission occasion. The switch may be triggered by an implicit indication to switch (e.g., the first PUSCH data) or by an explicit indication to switch (e.g., UCI).

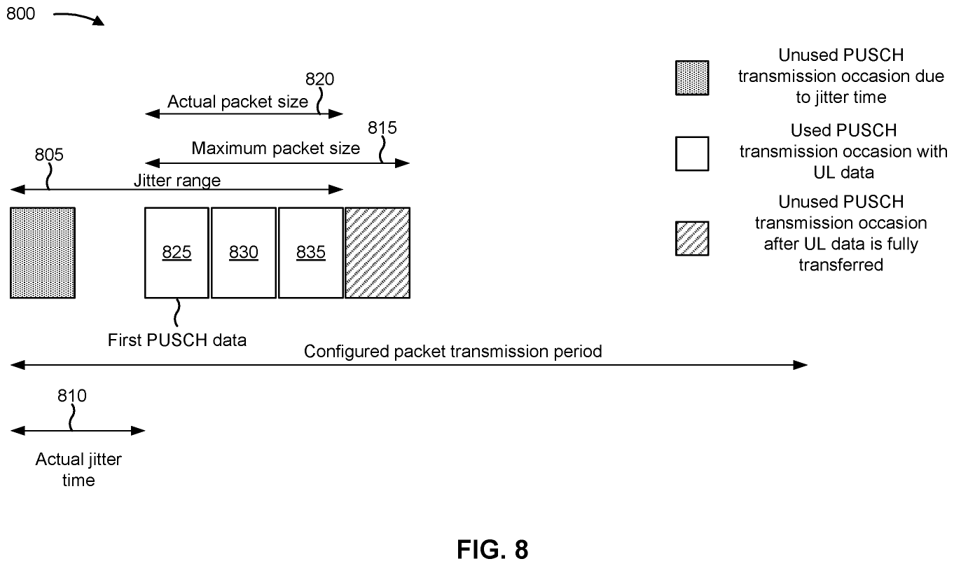

FIG. 8 is a diagram illustrating an example 800 of an implicit indication to switch from the first CG configuration to the second CG configuration, in accordance with the present disclosure. For example, the network node 110 may autonomously switch between the first CG configuration and the second CG configuration in response to detecting the first PUSCH data. Thus, the first PUSCH data may be an indication to switch from the first CG configuration to the second CG configuration.

As shown, due to jitter having a jitter range 805 and an actual jitter time 810, the uplink data of a packet having a maximum packet size 815 and an actual packet size 820 may start to be transmitted in the second PUSCH transmission occasion of the first CG configuration, which may contain relatively sparse PUSCH transmission occasions. Upon detecting the uplink data, the network node 110 may autonomously switch to the second CG configuration, which may contain relatively dense PUSCH transmission occasions. In example 800, three PUSCH transmission occasions 825, 830, and 835 may be used to transmit the uplink data, with one PUSCH transmission occasion 825 occurring when the first CG configuration is configured and the other two PUSCH transmission occasions 830 and 835 occurring when the second CG configuration is configured. Using the first PUSCH data as an indication to switch from the first CG configuration to the second CG configuration may avoid additional signaling regarding the switching and, as a result, may reduce overhead.

As indicated above, FIG. 8 is provided as an example. Other examples may differ from what is described with respect to FIG. 8.

In some examples, the UE 120 may transmit, and the network node 110 may receive, an indication (e.g., an explicit indication, such as UCI) to switch to the second CG configuration. For example, the UE 120 may transmit the UCI with or close to (e.g., within a threshold amount of time from) the first PUSCH data. For example, the UE may transmit the UCI with or close to the first PUSCH data when the jitter is unpredictable. Transmitting the indication to switch to the second CG configuration may increase robustness, for example, by helping to ensure that the network node 110 switches to the second CG configuration.

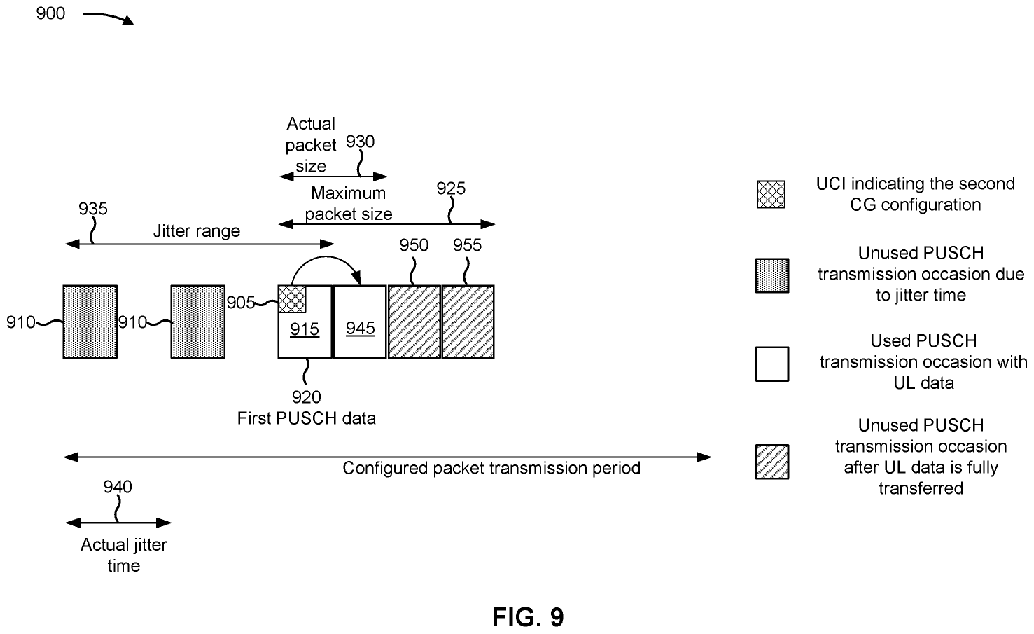

FIG. 9 is a diagram illustrating an example 900 associated with UCI 905 that includes an indication to switch to the second CG configuration, in accordance with the present disclosure. In some examples, the UE 120 may transmit, and the network node 110 may receive, the UCI 905 that includes an indication to switch to the second CG configuration. For example, the UCI may carry information regarding the second CG configuration and when to switch to the second CG configuration.

The UCI 905 may be included in a PUSCH transmission (e.g., a CG PUSCH transmission or a dynamic grant (DG) PUSCH transmission) or in a PUCCH transmission. In example 900, the UCI 905 is included in the PUSCH transmission. The UCI 905 may be encoded and multiplexed in the PUSCH transmission, for example, as CG-UCI for NR unlicensed (NRU) would be encoded and multiplexed, or as UCI used by a UE for an indication of unused CG PUSCH transmission occasion(s) (e.g., CG PUSCH transmission occasions 910) would be encoded and multiplexed. In some examples, the UCI 905 that includes the indication to switch to the second CG configuration may be a dedicated UCI. In some examples, the UCI 905 that includes the indication to switch to the second CG configuration may be added to the CG-UCI for NRU or the UCI used by a UE for an indication of unused CG PUSCH transmission occasion(s).

In example 900, the UE 120 may transmit the UCI 905 in the PUSCH transmission occasion 915 that carries the first (e.g., initial) PUSCH data 920 of the packet. The packet may have a maximum packet size 925 and an actual packet size 930. In this example, due to jitter, the UCI 905 and the first PUSCH data 920 are transmitted in the third PUSCH transmission occasion 915 of the first CG configuration. The jitter may have a jitter range 935 and an actual jitter time 940. One more PUSCH transmission occasion 945 (e.g., the first PUSCH transmission occasion of the second CG configuration) carries second PUSCH data of the packet. Thus, in example 900, a total of two PUSCH transmission occasions (e.g., PUSCH transmission occasions 915 and 945) are used to transmit the PUSCH data. PUSCH transmission occasions 950 and 955 may occur after the PUSCH data has been full transmitted and, therefore, may be unused.

As indicated above, FIG. 9 is provided as an example. Other examples may differ from what is described with respect to FIG. 9.

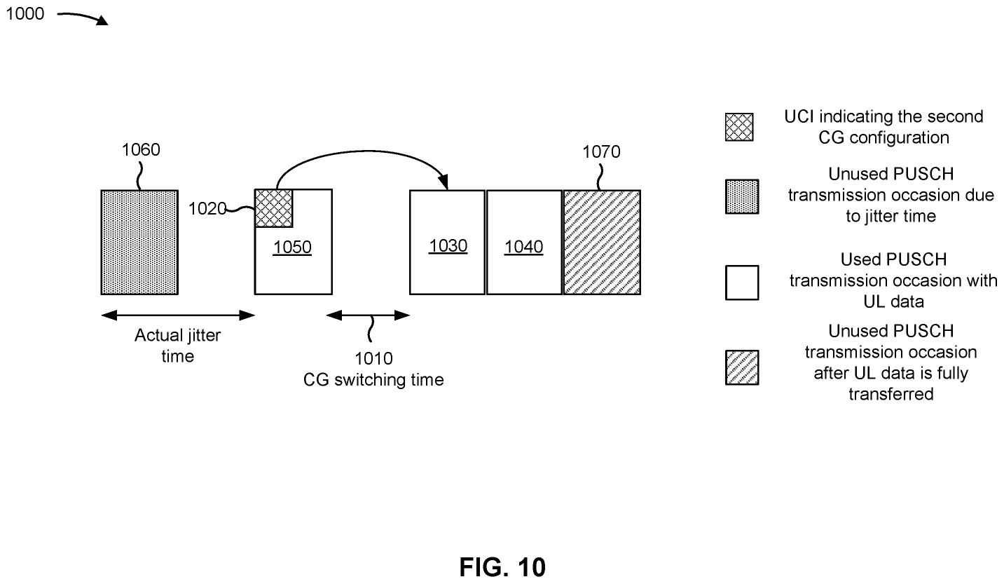

FIG. 10 is a diagram illustrating an example 1000 associated with a minimum time duration between transmission of the first PUSCH data or UCI that includes an indication to switch to the second CG configuration and transmission of the second PUSCH data, in accordance with the present disclosure. In some examples, a minimum time duration (also referred to as a switching time duration or an application delay) may persist between transmission of the first PUSCH data or the UCI that includes an indication to switch to the second CG configuration and transmission of the second PUSCH data. A minimum time duration for implicit CG configuration switching triggering (e.g., autonomous triggering by the network node 110) and a minimum time duration for explicit CG configuration switching triggering (e.g., when the UE 120 transmits UCI that includes an indication to switch to the second CG configuration) may be the same or different.

The minimum time duration may be configured by the network node 110 or may be selected by the UE 120. In case the minimum time duration is configured by the network node 110, the network node 110 may output, and the UE 120 may receive, a configuration of the minimum time duration. In case the minimum time duration is selected by the UE 120, the network node 110 may output, and the UE 120 may receive, an indication of a plurality of candidate minimum time durations between transmission of the first PUSCH data or the UCI that includes an indication to switch to the second CG configuration and transmission of the second PUSCH data. The UE 120 may select one of the plurality of candidate minimum time durations as a selected minimum time duration. The UE 120 may transmit, and the network node 110 may receive, the selected minimum time duration. For example, the selected minimum duration may be indicated in a UE capability report.

FIG. 10 illustrates the minimum time duration 1010 (“CG switching time”) as indicated by the network node 110 or as selected by the UE 120. The minimum switching time 1010 may be a minimum switching time between the first CG configuration or UCI 1020 that includes an indication to switch to the second CG configuration and the second CG configuration when the switch from the first CG configuration to the second CG configuration is indicated by the UE 120 (e.g., via UCI). If the network node 110 autonomously triggers the CG configuration switch (e.g., instead of the UE 120 triggering the CG configuration switch, as shown in FIG. 10), then a minimum time duration as indicated by the network node 110 or as selected by the UE 120 may be implemented between the first CG configuration (or UCI that includes an indication to switch to the second CG configuration) and the second CG configuration.

The minimum time duration 1010 may allow the UE 120 to start transmitting PUSCH data on PUSCH transmission occasion(s) (e.g., PUSCH transmission occasions 1030 and 1040) belonging to the second CG configuration after the PUSCH data has been transmitted on the first PUSCH transmission occasion(s) (e.g., PUSCH transmission occasion 1050) belonging to the first CG configuration. The minimum time duration 1010 may also provide sufficient time for the network node 110 to switch to the second CG configuration. As further shown in FIG. 10, unused PUSCH transmission occasion 1060 may occur before the PUSCH data is transmitted, and the PUSCH transmission occasion 1070 may occur after the PUSCH data has been full transmitted and, therefore, may be unused.

As indicated above, FIG. 10 is provided as an example. Other examples may differ from what is described with respect to FIG. 10.

A start time associated with the first CG configuration (e.g., the start time of the first CG configuration) may be configured with a configured start offset for the first PUSCH transmission occasion in the configured packet transmission period. The start time of the first CG configuration may be aligned with the nominal start time of an uplink data generation period.

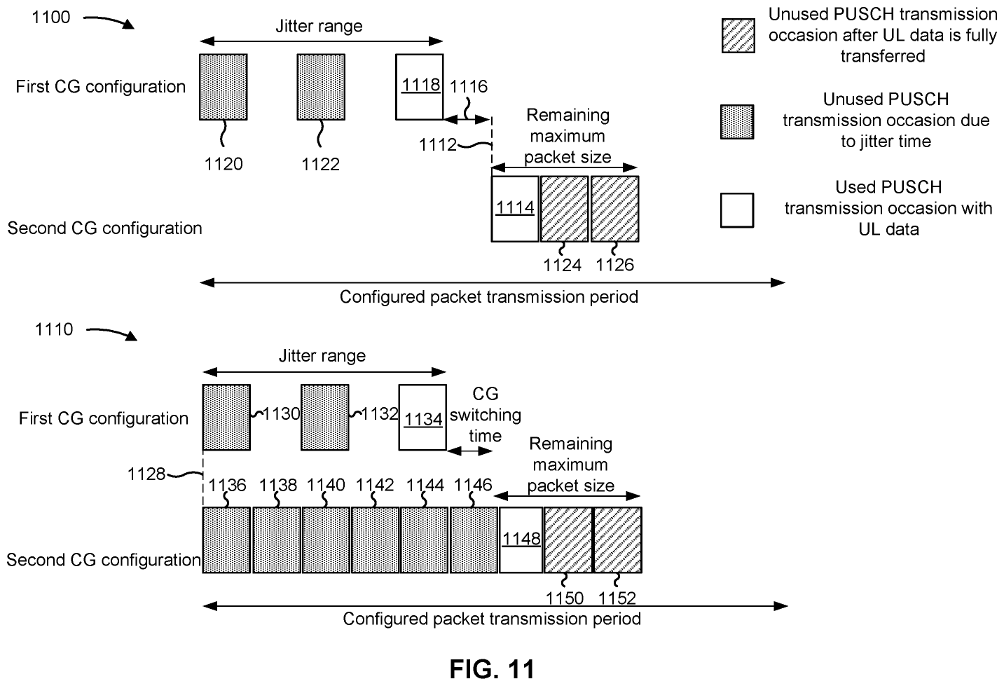

FIG. 11 is a diagram illustrating examples 1100 and 1110 associated with a start time associated with the second CG configuration (e.g., the start time of the second CG configuration), in accordance with the present disclosure. In example 1100, the start time associated with the second CG configuration is based at least in part on the transmission of the first PUSCH data (e.g., a floating start time 1112). For example, the floating start time 1112 may be based on the actual jitter value. For example, the first PUSCH transmission occasion 1114 in the second CG configuration may occur in a first slot configured for CG PUSCH transmission in accordance with the second CG configuration after the switch to the second CG configuration has been triggered. A minimum time duration 1116 (“CG switching time”) may be configured which persists between the first PUSCH data transmission (e.g., in the last-used PUSCH transmission occasion 1118 of the first CG configuration) or UCI that includes an indication to switch to the second CG configuration and the second PUSCH data transmission (e.g., in the first PUSCH transmission occasion 1114 of the second CG configuration). As further shown in example 1100, unused PUSCH transmission occasions 1120 and 1122 may occur before the PUSCH data is transmitted, and the PUSCH transmission occasions 1124 and 1126 may occur after the PUSCH data has been full transmitted and, therefore, may be unused.

In example 1110, the start time associated with the second CG configuration is configured (e.g., a configured start time 1128). As shown, the configured start time 1128 may be the same as the first CG configuration. In other examples, the configured start time may be offset from the start time of the configuration packet transmission period. As further shown, the first CG configuration may configure PUSCH transmission occasions 1130, 1132, and 1134, and the second CG configuration may configure PUSCH transmission occasions 1136, 1138, 1140, 1142, 1144, and 1146. In some examples, the PUSCH transmission occasions 1130, 1132, and 1134 of the first CG configuration may be aligned with a subset of the PUSCH transmission occasions of the second CG configuration (e.g., PUSCH transmission occasions 1136, 1140, and 1144), which may improve the robustness of the CG switching.

In some examples, the first CG configuration and the second CG configuration may be configured based on one or more RRC configurations. For example, the network node 110 may output, and the UE 120 may receive, a first RRC message configuring the first CG configuration and a second RRC message configuring the second CG configuration. For NR, the first RRC message and/or the second RRC message may include parameters such as ConfiguredGrantConfig, SL-ConfiguredGrantConfig, or the like. Configuring the first CG configuration and the second CG configuration using separate RRC CG configuration messages may provide flexibility for CG configuration switching. For example, any suitable configuration parameter in the first RRC message may differ from a corresponding configuration parameter in the second RRC message.

In some examples, the network node 110 may output, and the UE 120 may receive, an RRC message configuring the first CG configuration and the second CG configuration. For example, the same RRC CG configuration message may include different values for the same configuration parameter for the first CG configuration and second CG configuration. For example, for the ConfiguredGrantConfig parameter, a first timeDomainOffset field, a first timeDomainAllocation field, and/or a down-sampling factor may be provided for the first CG configuration, and a second timeDomainOffset field and/or a second timeDomainAllocation field may be provided for the second CG configuration. In some instances, the down-sampling factor may be provided for the first CG configuration, and may or may not be provided for the second CG configuration. Configuring the first CG configuration and the second CG configuration using the same RRC CG configuration message may reduce overhead.

In some examples, the UE 120 may transmit or receive, and the network node 110 may obtain or output, an indication enabling transmission of the first PUSCH data in the first PUSCH transmission occasion (e.g., PUSCH transmission occasion 1134) and enabling transmission of the second PUSCH data in the second PUSCH transmission occasion (e.g., PUSCH transmission occasion 1148). The indication may inform the network node 110 and/or the UE 120 that the PUSCH transmissions start during the initial CG configuration. In some examples, the network node 110 may configure the indication in an RRC message (e.g., an RRC CG configuration message). In some examples, the network node 110 may dynamically indicate the indication in a downlink signal (e.g., DCI, MAC control element (MAC-CE), or the like). In some examples, the UE 120 may dynamically indicate the indication in an uplink signal (e.g., UCI or the like). The indication may enable the network node 110 and UE 120 to switch from the first CG configuration to the second CG configuration (e.g., instead of obtaining or transmitting all PUSCH data for the packet using a single CG configuration). As further shown in example 1100, the PUSCH transmission occasions 1150 and 1152 may occur after the PUSCH data has been full transmitted and, therefore, may be unused.

FIG. 12 is a diagram illustrating an example process 1200 performed, for example, by a UE, in accordance with the present disclosure. Example process 1200 is an example where the UE (e.g., UE 120) performs operations associated with transmission of a packet via multiple CG configurations.

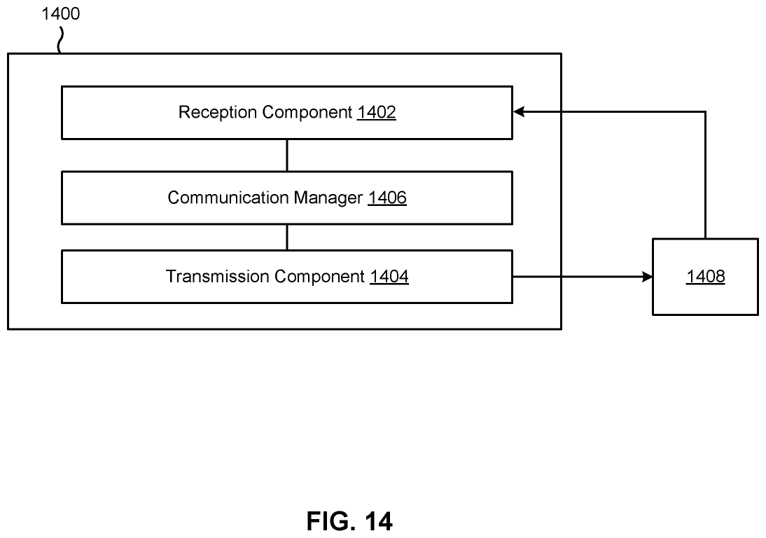

As shown in FIG. 12, in some aspects, process 1200 may include transmitting, in a first PUSCH transmission occasion of a first CG configuration, first PUSCH data of a packet (block 1210). For example, the UE (e.g., using transmission component 1404 and/or communication manager 1406, depicted in FIG. 14) may transmit, in a first PUSCH transmission occasion of a first CG configuration, first PUSCH data of a packet, as described above.

As further shown in FIG. 12, in some aspects, process 1200 may include transmitting, in a second PUSCH transmission occasion of a second CG configuration, second PUSCH data of the packet (block 1220). For example, the UE (e.g., using transmission component 1404 and/or communication manager 1406, depicted in FIG. 14) may transmit, in a second PUSCH transmission occasion of a second CG configuration, second PUSCH data of the packet, as described above.

Process 1200 may include additional aspects, such as any single aspect or any combination of aspects described below and/or in connection with one or more other processes described elsewhere herein.

In a first aspect, transmitting the first PUSCH data includes transmitting the first PUSCH data during a configured packet transmission period, and transmitting the second PUSCH data includes transmitting the second PUSCH data during the configured packet transmission period.

In a second aspect, alone or in combination with the first aspect, the first PUSCH data is an indication to switch to the second CG configuration.

In a third aspect, alone or in combination with one or more of the first and second aspects, process 1200 includes transmitting an indication to switch to the second CG configuration.

In a fourth aspect, alone or in combination with one or more of the first through third aspects, transmitting the indication to switch to the second CG configuration includes transmitting UCI that includes the indication to switch to the second CG configuration.

In a fifth aspect, alone or in combination with one or more of the first through fourth aspects, transmitting the UCI includes transmitting the UCI in the first PUSCH transmission occasion.

In a sixth aspect, alone or in combination with one or more of the first through fifth aspects, process 1200 includes receiving a configuration of a minimum time duration between transmission of the first PUSCH data or UCI that includes an indication to switch to the second CG configuration and transmission of the second PUSCH data.

In a seventh aspect, alone or in combination with one or more of the first through sixth aspects, process 1200 includes receiving an indication of a plurality of candidate minimum time durations between transmission of the first PUSCH data or UCI that includes an indication to switch to the second CG configuration and transmission of the second PUSCH data, and transmitting a selected minimum time duration of the plurality of candidate minimum time durations.

In an eighth aspect, alone or in combination with one or more of the first through seventh aspects, the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

In a ninth aspect, alone or in combination with one or more of the first through eighth aspects, the first plurality of PUSCH transmission occasions includes non-consecutive PUSCH transmission occasions, and the second plurality of PUSCH transmission occasions includes consecutive PUSCH transmission occasions.

In a tenth aspect, alone or in combination with one or more of the first through ninth aspects, the first plurality of PUSCH transmission occasions is down-sampled relative to the second plurality of PUSCH transmission occasions.

In an eleventh aspect, alone or in combination with one or more of the first through tenth aspects, a start time associated with the second CG configuration is based at least in part on transmission of the first PUSCH data.

In a twelfth aspect, alone or in combination with one or more of the first through eleventh aspects, a start time associated with the second CG configuration is configured.

In a thirteenth aspect, alone or in combination with one or more of the first through twelfth aspects, process 1200 includes receiving a first RRC message configuring the first CG configuration, and receiving a second RRC message configuring the second CG configuration.

In a fourteenth aspect, alone or in combination with one or more of the first through thirteenth aspects, process 1200 includes receiving an RRC message configuring the first CG configuration and the second CG configuration.

In a fifteenth aspect, alone or in combination with one or more of the first through fourteenth aspects, process 1200 includes transmitting or receiving an indication enabling transmission of the first PUSCH data in the first PUSCH transmission occasion and enabling transmission of the second PUSCH data in the second PUSCH transmission occasion.

In a sixteenth aspect, alone or in combination with one or more of the first through fifteenth aspects, transmitting the first PUSCH data includes transmitting the first PUSCH data before transmitting the second PUSCH data.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with transmission of a packet via multiple CG configurations.

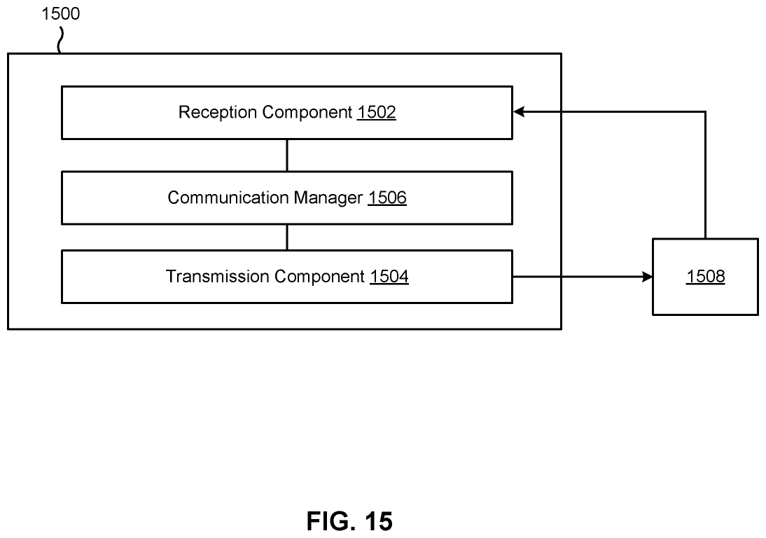

As shown in FIG. 13, in some aspects, process 1300 may include obtaining, in a first PUSCH transmission occasion of a first CG configuration, first PUSCH data of a packet (block 1310). For example, the network node (e.g., using reception component 1502 and/or communication manager 1506, depicted in FIG. 15) may obtain, in a first PUSCH transmission occasion of a first CG configuration, first PUSCH data of a packet, as described above.

As further shown in FIG. 13, in some aspects, process 1300 may include obtaining, in a second PUSCH transmission occasion of a second CG configuration, second PUSCH data of the packet (block 1320). For example, the network node (e.g., using reception component 1502 and/or communication manager 1506, depicted in FIG. 15) may obtain, in a second PUSCH transmission occasion of a second CG configuration, second PUSCH data of the packet, as described above.

Process 1300 may include additional aspects, such as any single aspect or any combination of aspects described below and/or in connection with one or more other processes described elsewhere herein.

In a first aspect, obtaining the first PUSCH data includes obtaining the first PUSCH data during a configured packet transmission period, and obtaining the second PUSCH data includes obtaining the second PUSCH data during the configured packet transmission period.

In a second aspect, alone or in combination with the first aspect, the first PUSCH data is an indication to switch to the second CG configuration.

In a third aspect, alone or in combination with one or more of the first and second aspects, process 1300 includes obtaining an indication to switch to the second CG configuration.

In a fourth aspect, alone or in combination with one or more of the first through third aspects, obtaining the indication to switch to the second CG configuration includes obtaining UCI that includes the indication to switch to the second CG configuration.

In a fifth aspect, alone or in combination with one or more of the first through fourth aspects, obtaining the UCI includes obtaining the UCI in the first PUSCH transmission occasion.

In a sixth aspect, alone or in combination with one or more of the first through fifth aspects, process 1300 includes outputting a configuration of a minimum time duration between transmission of the first PUSCH data or UCI that includes an indication to switch to the second CG configuration and transmission of the second PUSCH data.

In a seventh aspect, alone or in combination with one or more of the first through sixth aspects, process 1300 includes outputting an indication of a plurality of candidate minimum time durations between transmission of the first PUSCH data or UCI that includes an indication to switch to the second CG configuration and transmission of the second PUSCH data, and obtaining a selected minimum time duration of the plurality of candidate minimum time durations.

In an eighth aspect, alone or in combination with one or more of the first through seventh aspects, the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

In a ninth aspect, alone or in combination with one or more of the first through eighth aspects, the first plurality of PUSCH transmission occasions includes non-consecutive PUSCH transmission occasions, and the second plurality of PUSCH transmission occasions includes consecutive PUSCH transmission occasions.

In a tenth aspect, alone or in combination with one or more of the first through ninth aspects, the first plurality of PUSCH transmission occasions is down-sampled relative to the second plurality of PUSCH transmission occasions.

In an eleventh aspect, alone or in combination with one or more of the first through tenth aspects, a start time associated with the second CG configuration is based at least in part on transmission of the first PUSCH data.

In a twelfth aspect, alone or in combination with one or more of the first through eleventh aspects, a start time associated with the second CG configuration is configured.

In a thirteenth aspect, alone or in combination with one or more of the first through twelfth aspects, process 1300 includes outputting a first RRC message configuring the first CG configuration, and outputting a second RRC message configuring the second CG configuration.

In a fourteenth aspect, alone or in combination with one or more of the first through thirteenth aspects, process 1300 includes outputting an RRC message configuring the first CG configuration and the second CG configuration.

In a fifteenth aspect, alone or in combination with one or more of the first through fourteenth aspects, process 1300 includes transmitting or receiving an indication enabling transmission of the first PUSCH data in the first PUSCH transmission occasion and enabling transmission of the second PUSCH data in the second PUSCH transmission occasion.

In a sixteenth aspect, alone or in combination with one or more of the first through fifteenth aspects, obtaining the first PUSCH data includes obtaining the first PUSCH data before obtaining the second PUSCH data.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, in a first PUSCH transmission occasion of a first CG configuration, first PUSCH data of a packet. The transmission component 1404 may transmit, in a second PUSCH transmission occasion of a second CG configuration, second PUSCH data of the packet.

The transmission component 1404 may transmit the first PUSCH data during a configured packet transmission period.

The transmission component 1404 may transmit the second PUSCH data during the configured packet transmission period.

The transmission component 1404 may transmit an indication to switch to the second CG configuration.

The reception component 1402 may receive a configuration of a minimum time duration between transmission of the first PUSCH data or UCI that includes an indication to switch to the second CG configuration and transmission of the second PUSCH data.

The reception component 1402 may receive an indication of a plurality of candidate minimum time durations between transmission of the first PUSCH data or UCI that includes an indication to switch to the second CG configuration and transmission of the second PUSCH data.

The transmission component 1404 may transmit a selected minimum time duration of the plurality of candidate minimum time durations.

The reception component 1402 may receive a first RRC message configuring the first CG configuration.

The reception component 1402 may receive a second RRC message configuring the second CG configuration.

The reception component 1402 may receive an RRC message configuring the first CG configuration and the second CG configuration.

The reception component 1402 may receive an indication enabling transmission of the first PUSCH data in the first PUSCH transmission occasion and enabling transmission of the second PUSCH data in the second PUSCH transmission occasion.

The transmission component 1404 may transmit an indication enabling transmission of the first PUSCH data in the first PUSCH transmission occasion and enabling transmission of the second PUSCH data in the second PUSCH transmission occasion.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 6-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may obtain, in a first PUSCH transmission occasion of a first CG configuration, first PUSCH data of a packet. The reception component 1502 may obtain, in a second PUSCH transmission occasion of a second CG configuration, second PUSCH data of the packet.

The reception component 1502 may obtain the first PUSCH data during a configured packet transmission period.

The reception component 1502 may obtain the second PUSCH data during the configured packet transmission period.

The reception component 1502 may obtain an indication to switch to the second CG configuration.

The transmission component 1504 may output a configuration of a minimum time duration between transmission of the first PUSCH data or UCI that includes an indication to switch to the second CG configuration and transmission of the second PUSCH data.

The transmission component 1504 may output an indication of a plurality of candidate minimum time durations between transmission of the first PUSCH data or UCI that includes an indication to switch to the second CG configuration and transmission of the second PUSCH data.

The reception component 1502 may obtain a selected minimum time duration of the plurality of candidate minimum time durations.

The reception component 1502 may obtain an indication enabling transmission of the first PUSCH data in the first PUSCH transmission occasion and enabling transmission of the second PUSCH data in the second PUSCH transmission occasion.

The transmission component 1504 may output a first RRC message configuring the first CG configuration.

The transmission component 1504 may output a second RRC message configuring the second CG configuration.

The transmission component 1504 may output an RRC message configuring the first CG configuration and the second CG configuration.

The transmission component 1504 may output an indication enabling transmission of the first PUSCH data in the first PUSCH transmission occasion and enabling transmission of the second PUSCH data in the second PUSCH transmission occasion.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a UE, comprising: transmitting, in a first PUSCH transmission occasion of a first CG configuration, first PUSCH data of a packet; and transmitting, in a second PUSCH transmission occasion of a second CG configuration, second PUSCH data of the packet.

Aspect 2: The method of Aspect 1, wherein: transmitting the first PUSCH data includes transmitting the first PUSCH data during a configured packet transmission period; and transmitting the second PUSCH data includes transmitting the second PUSCH data during the configured packet transmission period.

Aspect 3: The method of any of Aspects 1-2, wherein the first PUSCH data is an indication to switch to the second CG configuration.

Aspect 4: The method of any of Aspects 1-3, further comprising: transmitting an indication to switch to the second CG configuration.

Aspect 5: The method of Aspect 4, wherein transmitting the indication to switch to the second CG configuration includes: transmitting uplink control information (UCI) that includes the indication to switch to the second CG configuration.

Aspect 6: The method of Aspect 5, wherein transmitting the UCI includes: transmitting the UCI in the first PUSCH transmission occasion.

Aspect 7: The method of any of Aspects 1-6, further comprising: receiving a configuration of a minimum time duration between transmission of the first PUSCH data or UCI that includes an indication to switch to the second CG configuration and transmission of the second PUSCH data.

Aspect 8: The method of any of Aspects 1-7, further comprising: receiving an indication of a plurality of candidate minimum time durations between transmission of the first PUSCH data or UCI that includes an indication to switch to the second CG configuration and transmission of the second PUSCH data; and transmitting a selected minimum time duration of the plurality of candidate minimum time durations.

Aspect 9: The method of any of Aspects 1-8, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

Aspect 10: The method of Aspect 9, wherein the first plurality of PUSCH transmission occasions includes non-consecutive PUSCH transmission occasions, and wherein the second plurality of PUSCH transmission occasions includes consecutive PUSCH transmission occasions.

Aspect 11: The method of Aspect 9, wherein the first plurality of PUSCH transmission occasions is down-sampled relative to the second plurality of PUSCH transmission occasions.

Aspect 12: The method of any of Aspects 1-11, wherein a start time associated with the second CG configuration is based at least in part on transmission of the first PUSCH data.

Aspect 13: The method of any of Aspects 1-12, wherein a start time associated with the second CG configuration is configured.

Aspect 14: The method of any of Aspects 1-13, further comprising: receiving a first RRC message configuring the first CG configuration; and receiving a second RRC message configuring the second CG configuration.

Aspect 15: The method of any of Aspects 1-14, further comprising: receiving an RRC message configuring the first CG configuration and the second CG configuration.

Aspect 16: The method of any of Aspects 1-15, further comprising: transmitting or receiving an indication enabling transmission of the first PUSCH data in the first PUSCH transmission occasion and enabling transmission of the second PUSCH data in the second PUSCH transmission occasion.

Aspect 17: The method of any of Aspects 1-16, wherein transmitting the first PUSCH data includes: transmitting the first PUSCH data before transmitting the second PUSCH data.

Aspect 18: A method of wireless communication performed by a network node, comprising: obtaining, in a first PUSCH transmission occasion of a first CG configuration, first PUSCH data of a packet; and obtaining, in a second PUSCH transmission occasion of a second CG configuration, second PUSCH data of the packet.

Aspect 19: The method of Aspect 18, wherein: obtaining the first PUSCH data includes obtaining the first PUSCH data during a configured packet transmission period; and obtaining the second PUSCH data includes obtaining the second PUSCH data during the configured packet transmission period.

Aspect 20: The method of any of Aspects 18-19, wherein the first PUSCH data is an indication to switch to the second CG configuration.

Aspect 21: The method of any of Aspects 18-20, further comprising: obtaining an indication to switch to the second CG configuration.

Aspect 22: The method of Aspect 21, wherein obtaining the indication to switch to the second CG configuration includes: obtaining uplink control information (UCI) that includes the indication to switch to the second CG configuration.

Aspect 23: The method of Aspect 22, wherein obtaining the UCI includes: obtaining the UCI in the first PUSCH transmission occasion.

Aspect 24: The method of any of Aspects 18-23, further comprising: outputting a configuration of a minimum time duration between transmission of the first PUSCH data or UCI that includes an indication to switch to the second CG configuration and transmission of the second PUSCH data.

Aspect 25: The method of any of Aspects 18-24, further comprising: outputting an indication of a plurality of candidate minimum time durations between transmission of the first PUSCH data or UCI that includes an indication to switch to the second CG configuration and transmission of the second PUSCH data; and obtaining a selected minimum time duration of the plurality of candidate minimum time durations.

Aspect 26: The method of any of Aspects 18-25, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

Aspect 27: The method of Aspect 26, wherein the first plurality of PUSCH transmission occasions includes non-consecutive PUSCH transmission occasions, and wherein the second plurality of PUSCH transmission occasions includes consecutive PUSCH transmission occasions.

Aspect 28: The method of Aspect 26, wherein the first plurality of PUSCH transmission occasions is down-sampled relative to the second plurality of PUSCH transmission occasions.

Aspect 29: The method of any of Aspects 18-28, wherein a start time associated with the second CG configuration is based at least in part on transmission of the first PUSCH data.

Aspect 30: The method of any of Aspects 18-29, wherein a start time associated with the second CG configuration is configured.

Aspect 31: The method of any of Aspects 18-30, further comprising: outputting a first RRC message configuring the first CG configuration; and outputting a second RRC message configuring the second CG configuration.

Aspect 32: The method of any of Aspects 18-31, further comprising: outputting an RRC message configuring the first CG configuration and the second CG configuration.

Aspect 33: The method of any of Aspects 18-32, further comprising: transmitting or receiving an indication enabling transmission of the first PUSCH data in the first PUSCH transmission occasion and enabling transmission of the second PUSCH data in the second PUSCH transmission occasion.

Aspect 34: The method of any of Aspects 18-33, wherein obtaining the first PUSCH data includes: obtaining the first PUSCH data before obtaining the second PUSCH data.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
transmit, in a first physical uplink shared channel (PUSCH) transmission occasion of a first configured grant (CG) configuration, first PUSCH data of a packet; and
transmit, in a second PUSCH transmission occasion of a second CG configuration, second PUSCH data of the packet.

2. The UE of claim 1, wherein:
the one or more processors, to transmit the first PUSCH data, are configured to transmit the first PUSCH data during a configured packet transmission period; and
the one or more processors, to transmit the second PUSCH data, are configured to transmit the second PUSCH data during the configured packet transmission period.

3. The UE of claim 1, wherein the first PUSCH data is an indication to switch to the second CG configuration.

4. The UE of claim 1, wherein the one or more processors are further configured to:
transmit an indication to switch to the second CG configuration.

5. The UE of claim 4, wherein the one or more processors, to transmit the indication to switch to the second CG configuration, are configured to:
transmit uplink control information (UCI) that includes the indication to switch to the second CG configuration.

6. The UE of claim 5, wherein the one or more processors, to transmit the UCI, are configured to:
transmit the UCI in the first PUSCH transmission occasion.

7. The UE of claim 1, wherein the one or more processors are further configured to:
receive a configuration of a minimum time duration between transmission of the first PUSCH data or uplink control information (UCI) that includes an indication to switch to the second CG configuration and transmission of the second PUSCH data.

8. The UE of claim 1, wherein the one or more processors are further configured to:
receive an indication of a plurality of candidate minimum time durations between transmission of the first PUSCH data or uplink control information (UCI) that includes an indication to switch to the second CG configuration and transmission of the second PUSCH data; and
transmit a selected minimum time duration of the plurality of candidate minimum time durations.

9. The UE of claim 1, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

10. The UE of claim 9, wherein the first plurality of PUSCH transmission occasions includes non-consecutive PUSCH transmission occasions, and wherein the second plurality of PUSCH transmission occasions includes consecutive PUSCH transmission occasions.

11. The UE of claim 9, wherein the first plurality of PUSCH transmission occasions is down-sampled relative to the second plurality of PUSCH transmission occasions.

12. The UE of claim 1, wherein a start time associated with the second CG configuration is based at least in part on transmission of the first PUSCH data.

13. The UE of claim 1, wherein a start time associated with the second CG configuration is configured.

14. The UE of claim 1, wherein the one or more processors are further configured to:
receive a first radio resource control (RRC) message configuring the first CG configuration; and
receive a second RRC message configuring the second CG configuration.

15. The UE of claim 1, wherein the one or more processors are further configured to:
receive a radio resource control (RRC) message configuring the first CG configuration and the second CG configuration.

16. The UE of claim 1, wherein the one or more processors are further configured to:
transmit or receive an indication enabling transmission of the first PUSCH data in the first PUSCH transmission occasion and enabling transmission of the second PUSCH data in the second PUSCH transmission occasion.

17. The UE of claim 1, wherein the one or more processors, to transmit the first PUSCH data, are configured to:
transmit the first PUSCH data before transmitting the second PUSCH data.

18. A network node for wireless communication, comprising:
one or more memories; and
one or more processors, coupled to the one or more memories, configured to:
obtain, in a first physical uplink shared channel (PUSCH) transmission occasion of a first configured grant (CG) configuration, first PUSCH data of a packet; and
obtain, in a second PUSCH transmission occasion of a second CG configuration, second PUSCH data of the packet.

19. The network node of claim 18, wherein the first PUSCH data is an indication to switch to the second CG configuration.

20. The network node of claim 18, wherein the one or more processors are further configured to:
obtain an indication to switch to the second CG configuration.

21. The network node of claim 18, wherein the one or more processors are further configured to:
output a configuration of a minimum time duration between transmission of the first PUSCH data or uplink control information (UCI) that includes an indication to switch to the second CG configuration and transmission of the second PUSCH data.

22. The network node of claim 18, wherein the one or more processors are further configured to:
output an indication of a plurality of candidate minimum time durations between transmission of the first PUSCH data or uplink control information (UCI) that includes an indication to switch to the second CG configuration and transmission of the second PUSCH data; and
obtain a selected minimum time duration of the plurality of candidate minimum time durations.

23. The network node of claim 18, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

24. A method of wireless communication performed by a user equipment (UE), comprising:
transmitting, in a first physical uplink shared channel (PUSCH) transmission occasion of a first configured grant (CG) configuration, first PUSCH data of a packet; and
transmitting, in a second PUSCH transmission occasion of a second CG configuration, second PUSCH data of the packet.

25. The method of claim 24, wherein the first PUSCH data is an indication to switch to the second CG configuration.

26. The method of claim 24, further comprising:
transmitting an indication to switch to the second CG configuration.

27. The method of claim 24, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.

28. A method of wireless communication performed by a network node, comprising:
obtaining, in a first physical uplink shared channel (PUSCH) transmission occasion of a first configured grant (CG) configuration, first PUSCH data of a packet; and
obtaining, in a second PUSCH transmission occasion of a second CG configuration, second PUSCH data of the packet.

29. The method of claim 28, further comprising:
obtaining an indication to switch to the second CG configuration.

30. The method of claim 28, wherein the first CG configuration is configured with a first plurality of PUSCH transmission occasions including the first PUSCH transmission occasion, wherein the second CG configuration is configured with a second plurality of PUSCH transmission occasions including the second PUSCH transmission occasion, and wherein the first plurality of PUSCH transmission occasions is less dense than the second plurality of PUSCH transmission occasions.
